(19) United States
(12) Patent Application Publication
(10) Pub. No.: US 2003/0085960 A1
(43) Pub. Date: May 8, 2003

(54) Monolithic ink-jet printhead and method of manufacturing the same

(75) Inventors: Il Kim, Suwon-city (KR); Seo-hyun Cho, Sungnam-city (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon City (KR)

(21) Appl. No.: 10/200,325

(22) Filed: Jul. 23, 2002

(30) Foreign Application Priority Data
Nov. 2, 2001 (KR) 2001-68246

(51) Int. Cl. B41J 2/05

(52) U.S. Cl. 347/65

(57) ABSTRACT

An ink-jet printhead includes a substrate; a doughnut-shaped heater formed on a top surface of the substrate; a nozzle plate stacked on the substrate, the nozzle plate having a nozzle through which ink is ejected; an ink chamber having a cavity enclosing the heater, the ink chamber communicating with the nozzle; and an ink passage extending through the substrate in a direction perpendicular to the surface of the heater. The ink passage includes a narrow passage and a wide passage which sequentially communicate with the ink chamber. The ink passage concentrically communicates with an opening at the center of the heater and the nozzle. The ink-jet printhead is monolithically manufactured for easy manufacturing, and since the introduction direction of ink into the ink chamber coincides with the ejection direction of ink from the nozzle, the ejection of ink can stably be performed.

### CROSS-REFERENCE TO RELATED APPLICATIONS

This application claims the benefit of Korean Application No. 2001-68246, filed Nov. 2, 2001, in the Korean Industrial Property Office, the disclosure of which is incorporated herein by reference.

### BACKGROUND OF THE INVENTION

1. Field of the Invention

The present invention relates to a thermal ink-jet printhead for use in an ink-jet printer or a facsimile machine, and more particularly, to a monolithic ink-jet printhead.

2. Description of the Related Art

In a general thermal ink-jet printhead, ink in an ink chamber is rapidly heated by a heater to generate bubbles, and a droplet of ink is ejected onto a print medium by the expansive force of the bubble to form an image on the print medium.

A conventional ink-jet printhead is generally produced by attaching a substrate in which the heater is formed and a nozzle plate in which nozzles are formed. However, according to such a method for manufacturing an ink-jet printhead, as the size of the nozzles is reduced and the number of the nozzles is increased, the manufacturing process becomes complicated, resulting in decreased productivity. Therefore, a so-called “monolithic” ink-jet printhead, for which the attachment process is not required, has been researched and developed.

An example of such a monolithic ink-jet printhead is shown in FIG. 1. As shown in FIG. 1, the conventional monolithic ink-jet printhead includes a substrate 1, a doughnut-shaped heater 2 formed on the top surface of the substrate 1 and having an opening at the center thereof, and a nozzle plate 3 stacked on the top surface of the heater 2. The substrate 1 includes an ink chamber 4 formed in the lower portion of the heater 2, and an ink passage 5 formed in communication with the ink chamber 4. The nozzle plate 3 is provided with a nozzle 3a communicating with the opening of the heater 2. The nozzle 3a, the opening of the heater 2, the ink chamber 4 and the ink passage 5 concentrically communicate with one another. Ink is introduced into the ink chamber 4 via the ink passage 5 and the opening of the heater 2, and is then ejected through the nozzle 3a by a bubble 6 growing due to the heat of the heater 2. Such an ink-jet printhead, in which the introduction direction of the ink into the ink chamber 4 and the ejection direction of the ink through the nozzle 3a are perpendicular to the surface of the heater 2, is referred to as a back-shooter type of ink-jet printhead. When the introduction and the ejection directions of ink coincide with each other, the ejection of ink is stably performed.

The process of manufacturing the ink-jet printhead in FIG. 1 will now be described. The heater 2 is first formed on the substrate 1 and the nozzle plate 3 is then stacked thereon by using, e.g., a chemical vapor deposition (“CVD”). Next, the nozzle 3a is formed in the nozzle plate 3. The opening is formed at the center of the heater 2 by etching the heater 2 through the nozzle 3a, and the ink chamber 4 and the ink passage 5 are sequentially formed by etching the substrate 1. The ink-jet printhead shown in FIG. 1 has a high productivity since it is manufactured by the monolithic process, without requiring attachment of the substrate 1 and the nozzle plate 3.

However, in the ink-jet printhead shown in FIG. 1, since the heater 2 is formed in the lower portion of the nozzle plate 3, the conduction path of the heat generated from the heater 2 is short. Therefore, the cooling rate of the heater 2 is low. In the ink-jet printhead, the number of ink droplets that can be ejected per hour, i.e., the ejection frequency, depends on the cooling rate of the heater 2. The low cooling rate of the heater 2 reduces the ejection frequency of the ink, resulting in low print speed of the printer. Furthermore, in the ink-jet printhead in FIG. 1, since the heater 2 is formed in the lower portion of the nozzle plate 3, the nozzle plate 3 is prone to be contaminated by ink sludge. Accordingly, more wiping is required than in other print head designs such as an edge-shooter type and a roof-shooter type.

Furthermore, in the ink-jet printhead shown in FIG. 1, since the nozzle plate 3 grows and is formed on the substrate 1 by using the CVD method, the thickness of the nozzle plate 3 is less than that (about 10 μm) of the ink-jet printhead produced by attaching the substrate 1 and the nozzle plate 3 so that the strength of the nozzle plate 3 is decreased.

Furthermore, in the ink-jet printhead, even though the introduction and the ejection directions of the ink coincide with each other, the ejection of ink is less stable than in the roof-shooter type of ink-jet printhead in which the introduction and the ejection directions of the ink are perpendicular to each other. This is because the thickness of the nozzle plate 3 is too small or the shape of the nozzle 3a cannot be ideally formed.

### SUMMARY OF THE INVENTION

Accordingly, an object of the present invention to provide a monolithic ink-jet printhead and a method of manufacturing the same, which has good ejection performance as well as a high productivity due to easy production thereof.

Additional objects and advantages of the invention will be set forth in part in the description which follows and, in part, will be obvious from the description, or may be learned by practice of the invention.

In accordance with one aspect of the present invention, there is provided an ink-jet printhead comprising: a substrate; a heater formed on the top surface of the substrate; a nozzle plate stacked on the substrate, the nozzle plate having a nozzle through which ink is ejected; a ink chamber having a cavity enclosing the heater, the ink chamber communicating with the nozzle; and an ink passage extending through the substrate in a direction perpendicular to the surface of the heater, the ink passage communicating with the ink chamber.

The heater has at the center an opening, and the opening concentrically communicates with the nozzle and the ink passage. The nozzle plate is formed by electroforming of Ni.

On the other hand, the ink passage includes: a narrow passage formed in the upper portion of the substrate, the narrow passage communication with the ink chamber; and a wide passage having a greater cross-sectional area than that of the narrow passage, the wide passage formed in the lower portion of the substrate and communicating with the narrow passage.

In accordance with another aspect of the present invention, there is provided a method of manufacturing an ink-jet printhead, the method comprising the steps of: forming an insulation film onto a substrate; depositing a metal layer onto the insulation film and patterning it to form a heater; forming a metal-wiring on the substrate; stacking a protective layer on the substrate; etching the substrate at a desired depth from the top surface of the substrate in a direction perpendicular to the surface of the heater to form a narrow passage; forming a seed layer on the protective layer; forming a sacrifice layer with a shape corresponding to a ink chamber above the heater; forming a nozzle plate above the substrate and the sacrifice layer; etching the substrate from the bottom surface thereof to form a wide passage communicating with the narrow passage; and removing the sacrifice layer.

The foregoing and other objects of the present invention are achieved by providing an ink-jet printhead, including a substrate; a heater formed on a top surface of the substrate; a nozzle plate stacked on the substrate, the nozzle plate having a nozzle through which ink is ejected; an ink chamber having a cavity enclosing the heater, the ink chamber communicating with the nozzle; and an ink passage extending through the substrate in a direction perpendicular to a surface of the heater, the ink passage communicating with the ink chamber.

The foregoing and other objects of the present invention are also achieved by providing a method of manufacturing an ink-jet printhead, including forming an insulation film on a substrate; depositing a metal layer onto the insulation film and patterning the metal layer to form a heater; forming a metal-wiring on the substrate; etching the substrate at a desired depth from a top surface of the substrate in a direction perpendicular to a surface of the heater to form a narrow passage; forming a sacrifice layer with a shape corresponding to an ink chamber above the heater; forming a nozzle plate above the substrate and the sacrifice layer; and etching the substrate from a bottom surface thereof to form a wide passage communicating with the narrow passage.

The foregoing and other objects of the present invention are achieved by providing a method of manufacturing an ink-jet printhead, including forming an insulation film on a substrate; depositing a metal layer onto the insulation film: patterning the metal layer to form a heater; forming a metal-wiring on the substrate; stacking a protective layer on the substrate; etching the substrate at a desired depth from a top surface of the substrate in a direction perpendicular to a surface of the heater to form a narrow passage; forming a seed layer on the protective layer; forming a sacrifice layer having a shape corresponding to an ink chamber formed in the substrate above the heater; forming a nozzle plate above the substrate and the sacrifice layer; etching the substrate from a bottom surface thereof to form a wide passage communicating with the narrow passage; and removing the sacrifice layer.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 shows a schematic cross-sectional view of a conventional ink-jet printhead;

FIG. 2 illustrates a schematic cross-sectional view of an ink-jet printhead in accordance with an embodiment of the present invention;

FIG. 3 is a cross-sectional view taken along line I-I in FIG. 2;

FIG. 4 depicts an alternative embodiment of the electrode and metal-wiring in the ink-jet printhead shown in FIG. 3;

FIGS. 5A to 5K are cross-sectional views sequentially showing the manufacturing process of the ink-jet printhead in FIG. 2;

FIGS. 6A to 6D are partial cross-sectional views showing various alternatives of the narrow passage in the ink-jet head shown in FIG. 2; and

FIG. 7 is a plan view showing an ink-jet printhead in accordance with another embodiment of the present invention, with the upper portion of the nozzle plate removed.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

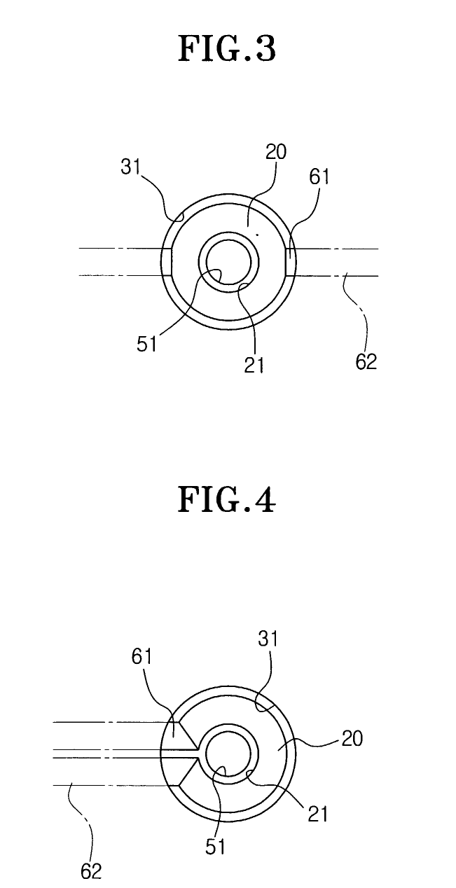

As shown in FIG. 2, an ink-jet printhead in accordance with an embodiment of the present invention includes a substrate 10 made of silicon or glass, a heater 20 formed on an upper portion of the substrate 10, a nozzle plate 40 stacked on the substrate 10 and having a nozzle 41 through which ink is ejected, an ink chamber 30 having a cavity communicating with the nozzle 41, and an ink passage 50 extending through the substrate 10 in a direction perpendicular to the surface of the heater 20.

Although not shown, a driving circuit to actuate the heater 20 is formed on the substrate 10. In order to electrically connect the driving circuit to the heater 20, an electrode 61 and a metal-wiring 62 are formed on an upper surface of the substrate 10. The electrode 61 is contacted with the heater 20. The metal-wiring 62 electrically connects the driving circuit to the electrode 61.

The ink chamber 30 is formed under the nozzle 41, i.e., in a lower side of the nozzle plate 40. The ink chamber 30 is defined by an ink chamber barrier 31, the substrate 10 and the heater 20, and has a cavity which is symmetric with respect to the nozzle 41.

The ink passage 50 includes a narrow passage 51 formed in the upper portion of the substrate 10 to communicate with the ink chamber 30, and a wide passage 52 formed in the lower portion of the substrate 10 to communicate with the narrow passage 51. The wide passage 52 has a cross-sectional area greater than that of the narrow passage 51. By making the cross-sectional area of the narrow passage 51 less than that of the wide passage 52 as described above, the ink filled in the ink chamber 30 is prevented from flowing back toward the wide passage 52.

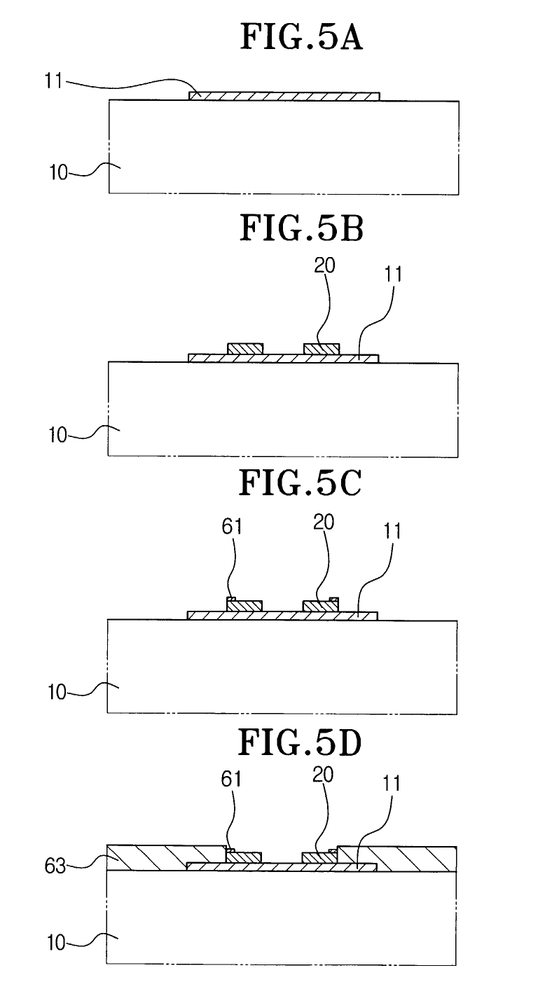

As shown in FIG. 3, the heater 20 has a doughnut shape with an opening 21 formed at the center. The opening 21 is arranged to concentrically communicate with the nozzle 41, the narrow passage 51 and the wide passage 52. The heater 20 is made of Ta-Al. Alternatively, the heater 20 may be made of TiN or TiW, which are proven to be stable in the semiconductor field, and may also be made of a Si-metal alloy capable of forming a stable oxide film.

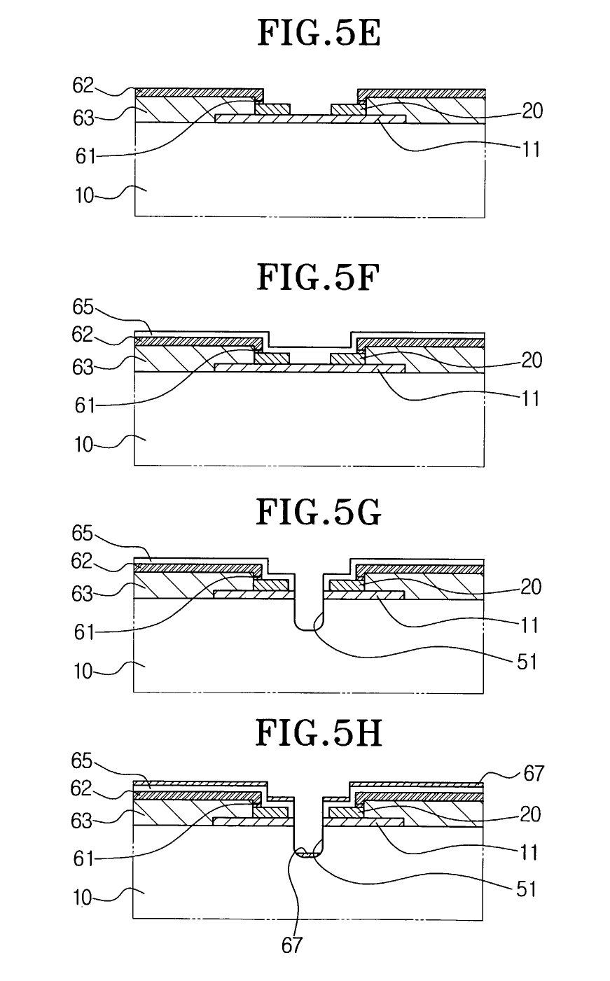

The electrode 61 is provided in a pair, and the pair of electrodes 61 are opposed to each other about the heater 20. That is, the pair of electrodes 61 are spaced at an angle of 180° around the heater 20 to contact opposite sides of the heater 20. On the other hand, as shown in FIG. 4, the pair of electrodes 61 may be disposed side-by-side to contact one side of the heater 20.

In the ink-jet printhead shown in FIG. 2, when electric current is applied from the driving circuit through the metal-wiring 62 and the electrodes 61 to the heater 20, the temperature of the heater 20 is increased. As the temperature of the heater 20 is increased, a bubble 70, formed on the surface of the heater 20, grows. An internal pressure of the ink chamber 30 is increased as the bubble 70 grows so that the ink filled in the ink chamber 30 is forced outward from the nozzle plate 40 through the nozzle 41, and grows in a column shape. At that time, when the amount of the current applied to the heater 20 is decreased or the current is cut off, the heater 20 is cooled and the bubble 70 shrinks. Due to the shrinkage of the bubble 70, a negative pressure is generated in the ink chamber 30 so that the ink column is necked. While a leading portion of the ink column becomes an ink droplet 80 which is then ejected onto the print medium, a trailing portion of the ink column is drawn back into the ink chamber 30. After the ink droplet 80 is ejected, the ink chamber 30 is replenished with ink through the ink passage 50 by capillary action.

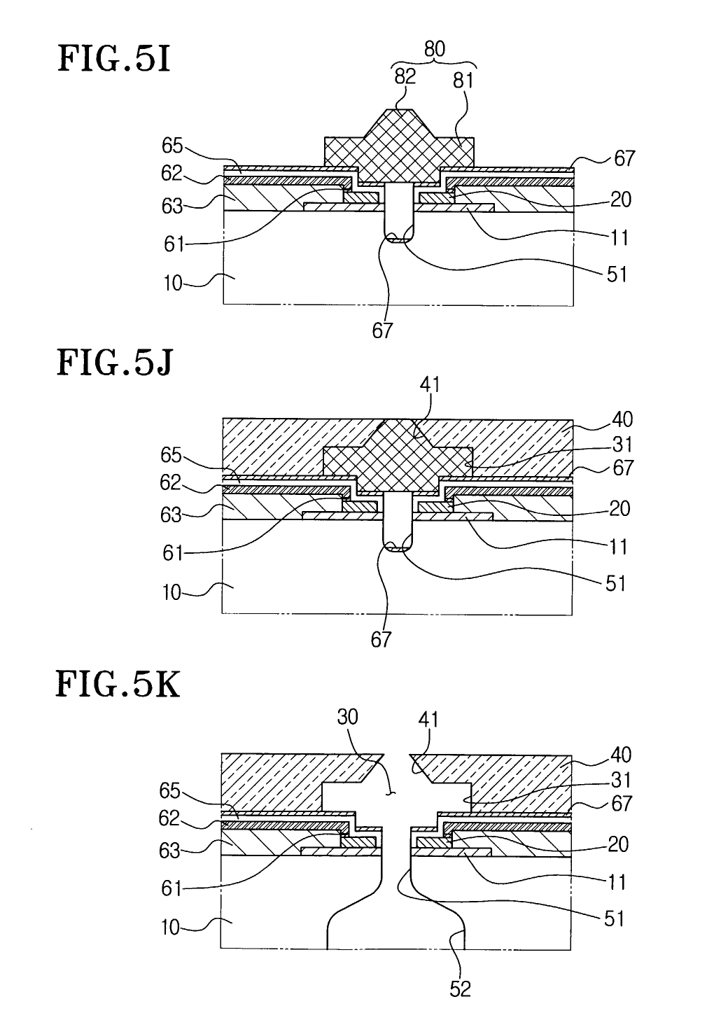

The process of manufacturing the ink-jet printhead shown in FIG. 2 will now be described with reference to FIGS. 5A to 5K.

(Driving Circuit Forming Process)

First, the driving circuit (not shown) to actuate the heater 20 is formed on the top surface of the substrate 10. The driving circuit is formed in a thin film transistor (“TFT”) fashion by using a standard negative metal oxide semiconductor (“NMOS”) process which is commonly used in the semiconductor manufacturing process. At that time, as shown in FIG. 5A, in order to insulate the heater 20 from the substrate 10, an insulation film 11 made of SiO₂ remains on the top surface of the substrate 10 in a region of the heater 20 (not yet formed).

(Heater Forming Process)

As shown in FIG. 5B, the metal layer of Ta—Al is deposited onto the insulation film 11, and the Ta—Al layer is etched in a doughnut-shape to form the heater 20.

(Metal-Wiring Forming Process)

As shown in FIG. 5C, an Al layer is deposited onto the top surfaces of the heater 20 and the driving circuit, and the Al layer is patterned to form the electrode 61 on the top surface of the heater 20 and the metal-wiring (now shown) on the top surface of the driving circuit. The metal-wiring may be formed in a single layer. However, especially in the case when a plurality of nozzles 41 are formed in the substrate 10, the metal wiring may be formed in two or more layers to connect the heater and the driving circuit located under each of the nozzles 41.

In order to form the metal-wiring of two layers, as shown in FIG. 5D, a boron phosphorus silicate glass (“BPSG”) is deposited onto the Al layer, and the BSPG is then etched to form an intermediate insulation film 63.

Next, as shown in FIG. 5E, the Al layer is again deposited onto the intermediate layer 63 and etched to form the metal-wiring 62 electrically connecting the driving circuit to the electrode 61.

On the other hand, the heater 20 and the metal-wiring 62 may simultaneously be patterned (not shown). In this case, the Ta—Al layer and the Al layer are in turn deposited on the substrate 10, the Ta—Al layer and the Al layer are simultaneously patterned along the pattern of the metal-wiring 62 except for the portion on which the heater 20 is formed. The Al layer is then removed from the top surface of the heater 20. At that time, in case the Ta—Al layer remains under the metal-wiring 62, the reliability of the metal-wiring 62 is increased, but the resistance between the Ta—Al layer and the driving circuit is increased. Accordingly, the Ta—Al layer contacting the driving circuit is removed.

(Protective Layer Forming Process)

As shown in FIG. 5F, a protective layer 65 made of Si₃N₄/SiC is deposited onto both the heater 20 and the metal-wiring 62. The protective layer 65 prevents the heater 20 and the metal-wiring 62 from reacting with the ink and insulates the heater 20. Further, the protective layer 65 protects the heater 20 from shock generated when the bubble 70 disappears.

(Narrow Passage Forming Process)

As shown in FIG. 5G, the narrow passage 51 is formed by etching the upper portion of the substrate 10 using a dry etching method. At that time, a depth of the narrow passage 51 is about 20 μm from the top surface of the substrate 10. A pattern of the narrow passage 51 as viewed from the top can be formed in various fashions by using a mask. As the mask, a general photo-resistor or the protective layer 65, which is patterned, may be used.

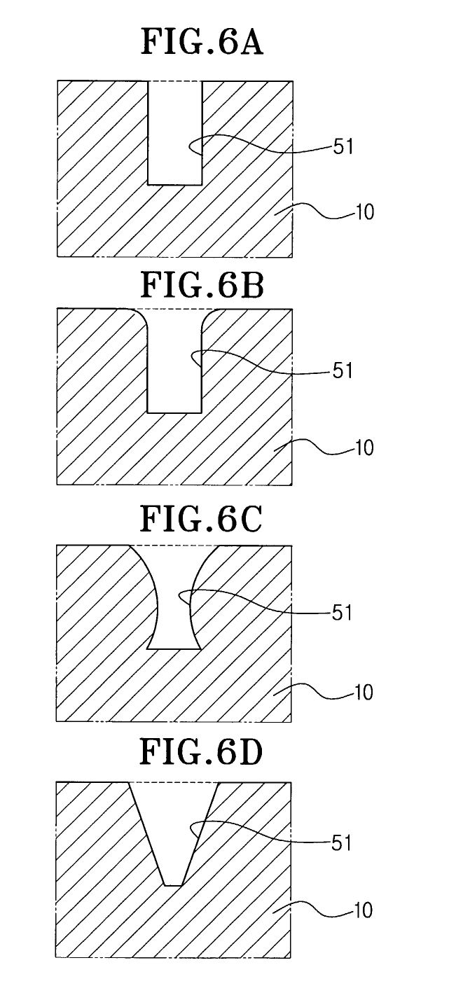

On the other hand, a shape of the narrow passage 51 in the cross-sectional view, is substantially rectangular, as shown in FIG. 6A, and may be varied by etching the substrate 10 using plasma. That is, the shape in cross-section of the narrow passage 51 may be formed in various fashions, such as a shape with the top end contacting the ink chamber 30 being rounded, as shown in FIG. 6B. Other shapes of the narrow passage 51 include the cross-sectional area in the central portion being less than a cross-sectional area of the upper and the lower portions (shown in FIG. 6C), and a trapezoidal shape (shown in FIG. 6D).

(Seed Layer Forming Process)

As shown in FIG. 5H, a conductive seed layer 67 is formed on both the top surface of the protective layer 65 and the bottom surface of the narrow passage 51. The seed layer 65 is needed to form the ink chamber 30 and the nozzle plate 40 over the protective layer 65 by electroforming. Furthermore, using the seed layer 67 stacked on the bottom surface of the narrow passage 51, when the substrate 10 is etched to form the wide passage 52, an exact ending point of etching can be determined. Accordingly, although the seed layer 67 may be formed prior to the formation of the narrow passage 51, in this example, the seed layer 67 is formed after the formation of the narrow passage 51 has been completed.

(Sacrifice Layer Forming Process)

As shown in FIG. 51, a sacrifice layer 90 is formed above the heater 20. The sacrifice layer 90 includes an ink chamber sacrifice layer 91 having a shape corresponding to the ink chamber 30 and a nozzle sacrifice layer 92 having a shape corresponding to the nozzle 41. Liquid photoresist or a dry film may be used as the sacrifice layer 90. Since the narrow passage 51 is provided below the sacrifice layer 90, it is more difficult to obtain the flatness of the top surface of the sacrifice layer 90 using the liquid photoresist, so the dry film is used in this example. The nozzle sacrifice layer 92 to form the nozzle 41 having an exact shape, which is formed at the upper center portion of the nozzle sacrifice layer 92 and projects therefrom, is formed by exposing the sacrifice layer 90 to light in two steps. Alternately, if the nozzle sacrifice layer 82 is not used, the nozzle 41 may be formed by electroforming upon the formation of the nozzle plate 40 (which will be described hereinafter) except for the portion in which the nozzle 41 is formed.

(Ink chamber and Nozzle Plate Forming Process)

As shown in FIG. 5J, the nozzle plate 40 is formed by electroforming the substrate 10 and the sacrifice layer 90 with Ni. The portion of the nozzle plate 40, which contacts the peripheral surface of the ink chamber sacrifice layer 91, becomes the ink chamber barrier 31. Furthermore, the portion which contacts the peripheral surface of the nozzle sacrifice layer 92 becomes the nozzle 41. Due to the fine variation of composition or the fine difference in micro structure of Ni to be electroforming-plated, the reactivity of Ni and ink is significantly varied. In order to control the reactivity of the electroforming plated Ni and the ink, therefore, the temperature of electroforming and the current density in plating, together with the amount of the plating liquid, must be controlled. Alternately, instead of electroforming the Ni, the nozzle plate 40 may be formed using a material including a polymer capable of forming a micro structure on the sacrifice layer 90.

After the nozzle plate 40 has been formed, polytetrafluorethylene (“PTFE”) may be eutectoid-plated on the nozzle plate 40. After the plating of PTFE has been performed, a hydrophobic thin film layer with high wear-resistance is formed on an outer surface of the nozzle plate 40 by heat treatment. Such heat treatment may be performed after the formation of the wide passage 52 has been completed.

(Wide Passage Forming Process)

As shown in FIG. 5K, when the formation of the ink chamber 30 and the nozzle plate 40 by electroforming has been completed, the wide passage 52 is formed by etching the lower portion of the substrate 10 using the dry etching method. In order to form the wide passage 52, the silicon oxide film (not shown) deposited on the bottom surface of the substrate 10 is patterned and used as a mask. The silicon oxide film is formed in the initial step of the process of manufacturing the substrate 10.

When the wide passage 52 is formed, the depth of etching is critical. If the depth of etching is too great, there is a risk that the narrow passage 51 becomes too short or disappears; and if the depth of etching is too small, the wide passage 52 does not communicate with the narrow passage 51. Therefore, the point at which the wide passage 52 and the narrow passage 51 come to meet each other, i.e., the ending point of etching, is determined while observing the processing state of the substrate 10 rather than by using the etching time.

The method of determining the ending point of etching includes a method using an optical sensor, a method of analyzing the plasma composition, or a method of measuring the difference in bias voltage applied to the electrode generating plasma.

In the present embodiment, the plasma composition analyzing method is used to determine the ending point of etching. The plasma composition analyzing method is to determine the ending point of etching by analyzing the composition of plasma while etching the substrate 10. As described above, the seed layer 67, which is of a different composition from the substrate 10, is stacked on the bottom surface of the narrow passage 51. Therefore, when the etching of the substrate 10 progresses and the wide passage 52 comes to communicate with the narrow passage 51, the seed layer 67 is etched, thereby varying the composition of the plasma. At that time, the etching is finished.

Alternately, since the fluid flows smoothly in the ink-jet printhead after the ink passage 50 has been completely formed, the sacrifice layer 90 is removed after the formation of the wide passage 52 has been completed.

(Hydrophobic Thin Film Coating Process)

On the other hand, instead of eutectoid plating with PTFE after the formation of the nozzle plate 40, the hydrophobic thin film may be coated on the surface of the nozzle plate 40 by a directional deposition method using plasma prior to the removal of the sacrifice layer 90. When coated on the surface of the nozzle plate 40, the hydrophobic thin film is substantially not coated on the surface of the heater 20 because the opening 21 (see FIG. 3) of the heater 20 is located below the nozzle 41.

(Ink Wettability Enhanced Process)

In the ink chamber barrier 31 having the substrate 10 made of silicon, the ink wettability is poor. In order to improve the ink wettability in the narrow and the wide passages 51, 52 and the ink chamber 30, liquid or gas, which has a good ink wettability, is flowed into the narrow and the wide passages 51, 52 and the ink chamber 30. The liquid or gas contains a similar composition to the ink.

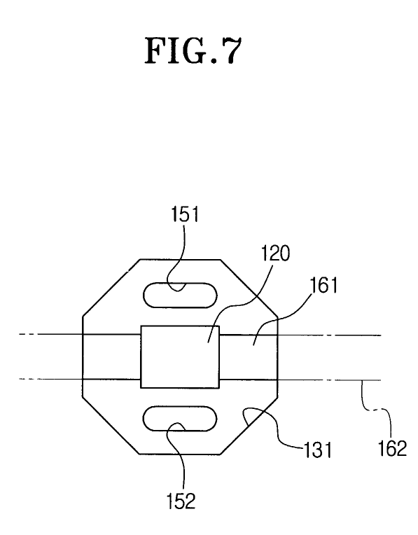

FIG. 7 shows another embodiment of the present invention with respect to the configuration of the heater and the orientation of the ink passage.

An ink-jet printhead shown in FIG. 7 includes a rectangular heater 120, an ink chamber barrier 131 enclosing the heater 120, and a pair of ink passages 151, 152 disposed on the right and the left sides of the heater 120. The heater 120 is electrically connected to a driving circuit (not shown) through an electrode 161 and a metal-wiring 162. The ink passages 151, 152, similar to the ink passage 50 of the ink-jet printhead in FIG. 2, are formed perpendicular to the surface of the heater 120 and may each include a narrow passage and a wide passage communicating with each other. The ink-jet printhead in FIG. 7 has the same construction as the ink-jet printhead in FIG. 2 except for the configuration of the heater 120 and the number of the ink passages 151, 152. As in the ink-jet printhead in FIG. 7, the plurality of ink passages 151, 152 formed in one ink chamber reduce the surface area per ink passage compared with the ink-jet printhead in FIG. 2. Accordingly, the flatness of the sacrifice layer 90 (see FIG. 51) is improved when the ink-jet printhead is manufactured.

As described above, according to the ink-jet printhead of the present invention, since the introduction direction of ink into the ink chamber 30 via the ink passage 50 and the ejection direction of ink from the ink chamber 30 through the nozzle 41 are coincident with each other, the ejection of ink is stable and the cross-talk between the adjacent nozzles is reduced.

Furthermore, since the present ink-jet printer is manufactured by a monolithic process wherein the ink chamber 30 and the nozzle plate 40 are formed by electroforming of Ni onto the substrate 10, the attachment process is not required in the manufacturing process, thereby resulting in an easy production and hence a high productivity.

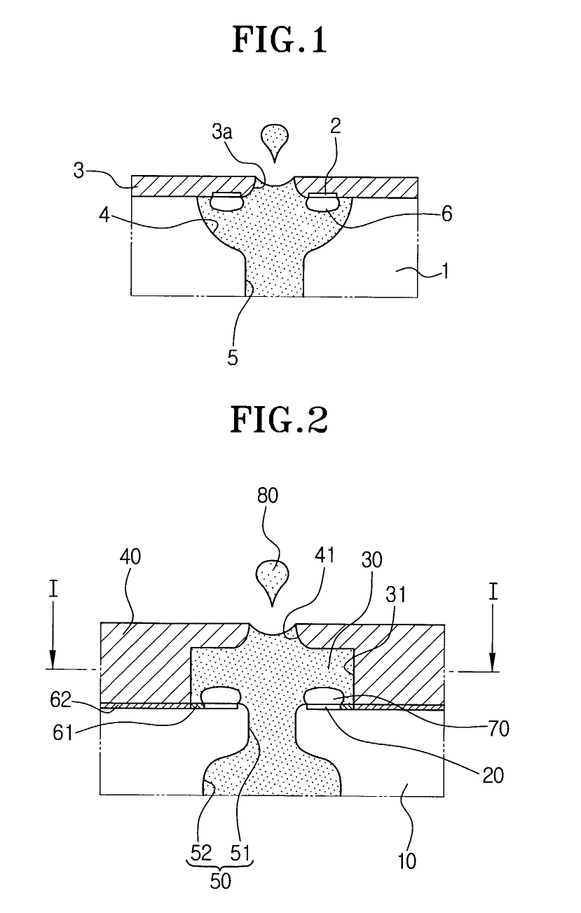

Furthermore, in the ink-jet printhead, the ink chamber barrier 31 is provided below the nozzle plate 40. Therefore, in comparison with the back-shooter type of ink-jet printhead shown in FIG. 1, the ink ejection frequency is increased due to the high cooling rate of the heater 20 and the strength of the nozzle plate 40 is increased because of increased thickness of the portion of the nozzle plate 40 in which the nozzle 41 is formed.

Furthermore, in the ink-jet printhead of the present invention, the ink chamber 30 is symmetric with respect to the center point of the nozzle 41 so that the roundness of the nozzle 41, which is formed after the ink chamber 30 has been formed, is improved.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. An ink-jet printhead, comprising:
a substrate;
a heater formed on a top surface of the substrate;
a nozzle plate stacked on the substrate, the nozzle plate having a nozzle through which ink is ejected;
an ink chamber having a cavity enclosing the heater, the ink chamber communicating with the nozzle; and
an ink passage extending through the substrate in a direction perpendicular to a surface of the heater, the ink passage communicating with the ink chamber.

2. The ink-jet printhead of claim 1, wherein the heater comprises an opening at a center portion thereof, and the opening concentrically communicates with the nozzle and the ink passage.

3. The ink-jet printhead of claim 2, wherein the nozzle plate is formed by an Ni electroforming.

4. The ink-jet printhead of claim 1, wherein the ink passage comprises:
a narrow passage formed in an upper portion of the substrate, the narrow passage communicating with the ink chamber; and
a wide passage having a greater cross-sectional area than a cross sectional area of the narrow passage, the wide passage formed in a lower portion of the substrate and communicating with the narrow passage.

5. The ink-jet printhead of claim 1, further comprising a pair of the ink passages, wherein the heater is disposed between the pair of the ink passages.

6. The ink-jet printhead of claim 5, wherein each of the pair of the ink passages comprises:
a narrow passage formed in an upper portion of the substrate, the narrow passage communicating with the ink chamber; and
a wide passage having a greater cross-sectional area than a cross sectional area of the narrow passage, the wide passage formed in a lower portion of the substrate and communicating with the narrow passage.

7. The ink-jet printhead of claim 2, further comprising:
a metal wiring;
a driving circuit to actuate the heater, the driving circuit formed on the substrate; and
an electrode comprising:
a first end electrically connected to the heater, and
a second end connected through the metal-wiring to the driving circuit.

8. The ink-jet printhead of claim 7, further comprising a pair of the electrodes opposed to each other about the heater.

9. The ink-jet printhead of claim 7, further comprising a pair of the electrodes disposed side by side and contacting a side of the heater.

10. The ink-jet printhead of claim 7, wherein the driving circuit is a TFT.

11. The ink-jet printhead of claim 1, wherein the substrate comprises silicon or glass.

12. A method of manufacturing an ink-jet printhead, comprising:
forming an insulation film on a substrate;
depositing a metal layer onto the insulation film and patterning the metal layer to form a heater;
forming a metal-wiring on the substrate;
etching the substrate at a desired depth from a top surface of the substrate in a direction perpendicular to a surface of the heater to form a narrow passage;
forming a sacrifice layer with a shape corresponding to an ink chamber above the heater;
forming a nozzle plate above the substrate and the sacrifice layer; and
etching the substrate from a bottom surface thereof to form a wide passage communicating with the narrow passage.

13. The method of claim 12, wherein the nozzle plate is formed by an Ni electroforming.

14. The method of claim 12, wherein the insulation film is formed using a standard NMOS process.

15. The method of claim 12, wherein the metal-wiring comprises first and second layers, and the method further comprises:
depositing BPSG between the first and second layers; and
etching the BPSG to form an intermediate insulation layer.

16. The method of claim 12, further comprising:
stacking a protective layer on the heater after the formation of the metal-wiring has been completed.

17. The method of claim 16, wherein the protective layer comprises Si₃N4/Sic.

18. The method of claim 16, further comprising:
forming a seed layer on the protective layer after the formation of the narrow passage has been completed.

19. The method of claim 18, wherein the wide passage is formed by a dry etching using plasma.

20. The method of claim 18, further comprising:
determining an end point of the etching of the substrate to form the wide passage by analyzing a variation of a plasma composition.

21. The method of claim 16, further comprising:
forming a seed layer on the protective layer prior to the formation of the narrow passage.

22. The method of claim 12, further comprising forming a nozzle in the nozzle plate, wherein the sacrifice layer comprises:
an ink chamber sacrifice layer having a shape corresponding to the ink chamber; and
a nozzle sacrifice layer formed above the ink chamber sacrifice layer, the nozzle sacrifice layer having a shape corresponding to the nozzle.

23. The method of claim 22, wherein the sacrifice layer is formed of a dry film.

24. The method of claim 12, further comprising eutectoid plating PTFE on the nozzle plate.

25. The method of claim 12, further comprising removing the sacrifice layer after the formation of the wide passage.

26. The method of claim 25, further comprising depositing a hydrophobic thin film onto a surface of the nozzle plate prior to the removal of the sacrifice layer.

27. The method of claim 12, wherein ink is disposed in the ink chamber, and the method further comprises flowing liquid or gas having a composition similar to the ink into the narrow passage, the wide passage and the ink chamber after the formation of the wide passage.

28. A method of manufacturing an ink-jet printhead, comprising:
forming an insulation film on a substrate;
depositing a metal layer onto the insulation film;
patterning the metal layer to form a heater;
forming a metal-wiring on the substrate;
stacking a protective layer on the substrate;
etching the substrate at a desired depth from a top surface of the substrate in a direction perpendicular to a surface of the heater to form a narrow passage;
forming a seed layer on the protective layer;
forming a sacrifice layer having a shape corresponding to an ink chamber formed in the substrate above the heater;
forming a nozzle plate above the substrate and the sacrifice layer;
etching the substrate from a bottom surface thereof to form a wide passage communicating with the narrow passage; and
removing the sacrifice layer.

29. The method of claim 28, further comprising eutectoid plating PTFE on the nozzle plate.

30. The method of claim 28, further comprising depositing a hydrophobic thin film onto a surface of the nozzle plate.

31. The method of claim 29, wherein ink is disposed in the ink chamber, and the method further comprises flowing liquid or gas having a composition similar to the ink into the narrow passage, the wide passage and the ink chamber after the formation of the wide passage.

32. An ink-jet printhead, comprising:
a substrate;
a nozzle plate on the substrate, the nozzle plate having a nozzle through which ink is ejected;
an ink chamber formed by the nozzle plate, the ink chamber communicating with the nozzle; and
an ink passage extending through the substrate and communicating with the ink chamber.

33. The ink-jet printhead of claim 32, further comprising a heater between the substrate and the nozzle plate, wherein the ink passage extends in a direction perpendicular to a surface of the heater.

34. The ink-jet printhead of claim 32, wherein the ink-jet printhead is monolithic.

35. The ink-jet printhead of claim 32, wherein the ink passage comprises:
a first passage formed in the substrate, the first passage communicating with the ink chamber and having a first cross sectional area; and
a second passage having a second cross sectional area greater than the first cross sectional area, the second passage communicating with the first passage.

36. The ink-jet printhead of claim 35, further comprising:
a doughnut shaped heater between the substrate and the nozzle plate;
a first electrode electrically connected to the heater; and
a second electrode electrically connected to the heater and on an opposite side of the heater from the first electrode.

37. The ink-jet printhead of claim 35, further comprising:
a doughnut shaped heater between the substrate and the nozzle plate;
a first electrode electrically connected to the heater; and
a second electrode electrically connected to the heater and on a same side of the heater as the first electrode.

38. The ink-jet printhead of claim 32, further comprising:
a rectangular heater between the substrate and the nozzle plate;
a first electrode electrically connected to the heater;
a second electrode electrically connected to the heater and on an opposite side of the heater from the first electrode.

39. The ink-jet printhead of claim 38, wherein the ink passage comprises first and second ink passages on opposite sides of the heater from each other.

40. An ink-jet printhead, comprising:
a substrate;
a nozzle plate stacked on the substrate, the nozzle plate having a nozzle through which ink is ejected;
an ink chamber, defined by an ink chamber barrier which is formed integrally with the nozzle plate, the ink chamber communicating with the nozzle; and
an ink passage extending through the substrate and communicating with the ink chamber.
